(19) United States
(12) Patent Application Publication
(10) Pub. No.: US 2011/0067618 A1
(43) Pub. Date: Mar. 24, 2011

(54) Water-Based Material Transportation System

(76) Inventor: Harry Edward Dempster, Newbury Park, CA (US)

(21) Appl. No.: 12/888,353

(22) Filed: Sep. 22, 2010

Related U.S. Application Data
(60) Provisional application No. 61/245,354, filed on Sep. 24, 2009.

(51) Int. Cl. B63G 8/08; B63G 8/00; G05D 1/00

(52) U.S. Cl. 114/321; 701/21

(57) ABSTRACT

Provided are, among other things, systems, methods and techniques for water-based material transportation, such as a system that includes: (a) a robotic submersible propulsion unit having: a thruster, a computer controller that is coupled to and configured to control the thruster and that causes the robotic submersible propulsion unit to follow a predetermined course, and an attachment fitting; and (b) a submersible transport barge having: a storage tank, a locking port at a first end of the submersible transport barge that detachably connects to the attachment fitting of the robotic submersible propulsion unit, and a loading/downloading connection at a second end of the submersible transport barge that detachably connects to a transfer connection dock for transferring material between the storage tank and the transfer connection dock.

This application claims the benefit of U.S. Provisional Patent Application Ser. No. 61/245,354, filed on Sept. 24, 2009, and titled “Subsurface Robotic LNG Distribution System”, which application is incorporated by reference herein as though set forth herein in full.

### FIELD OF THE INVENTION

The present invention pertains to systems, methods, apparatuses and techniques for water-based transportation of various kinds of materials, such as liquefied natural gas, liquefied hydrogen, oil and/or purified or desalinated water. It is particularly applicable to transportation of materials from the source at which they are generated or extracted to the locations where they are actually used.

### BACKGROUND

Alaska has an estimated natural gas reserve of 230 trillion cubic feet, a huge amount of clean energy that could move the United States toward energy independence. However, one problem is how to quickly and cost-effectively get this energy to the market without endangering the environment. In fact, a major problem in utilizing a variety of resources (particularly energy resources) is how to cost-effectively store and transport them.

### SUMMARY OF THE INVENTION

This problem can be solved, e.g., by using a transport system according to the present invention. For example, the present invention addresses the problems noted above by, among other things, providing a cost-effective automated and/or robotic system that collects, transports, stores and widely distributes extracted or generated gases (or other types of materials), often with little or no damage to the environment or view shed.

One embodiment of the invention is directed to a system that includes: (a) a robotic submersible propulsion unit having: a thruster, a computer controller that is coupled to and configured to control the thruster and that causes said robotic submersible propulsion unit to follow a predetermined course, and an attachment fitting; and (b) a submersible transport barge having: a storage tank, a locking port at a first end of the submersible transport barge that detachably connects to the attachment fitting of the robotic submersible propulsion unit, and a loading/downloading connection at a second end of the submersible transport barge that detachably connects to a transfer connection dock for transferring material between the storage tank and the transfer connection dock

By virtue of the foregoing arrangement, it could be possible for the United States once again to take the lead in energy production while at the same time reducing worldwide pollution.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a perspective drawing showing a transport barge 100 connected to and being pushed by a submarine tug 200.

FIG. 2 is a mid sectional view of the transport barge 100 attached to tug 200.

FIG. 3 is a side elevational view of an automated or robotic tug 200.

FIG. 4 is a top plan view of the transport barge 100 and tug 200.

FIG. 5 is a perspective view of tug 200.

FIG. 6 is a cutaway view showing the transport barge 100 floating on the ocean surface as it enters a transfer connection dock 300.

FIG. 7 is a side elevational of view of an entire system, including a pumping terminal, a conversion unit and a storage unit, moored below wave action in an operational mode.

### DESCRIPTION OF THE PREFERRED EMBODIMENT(S)

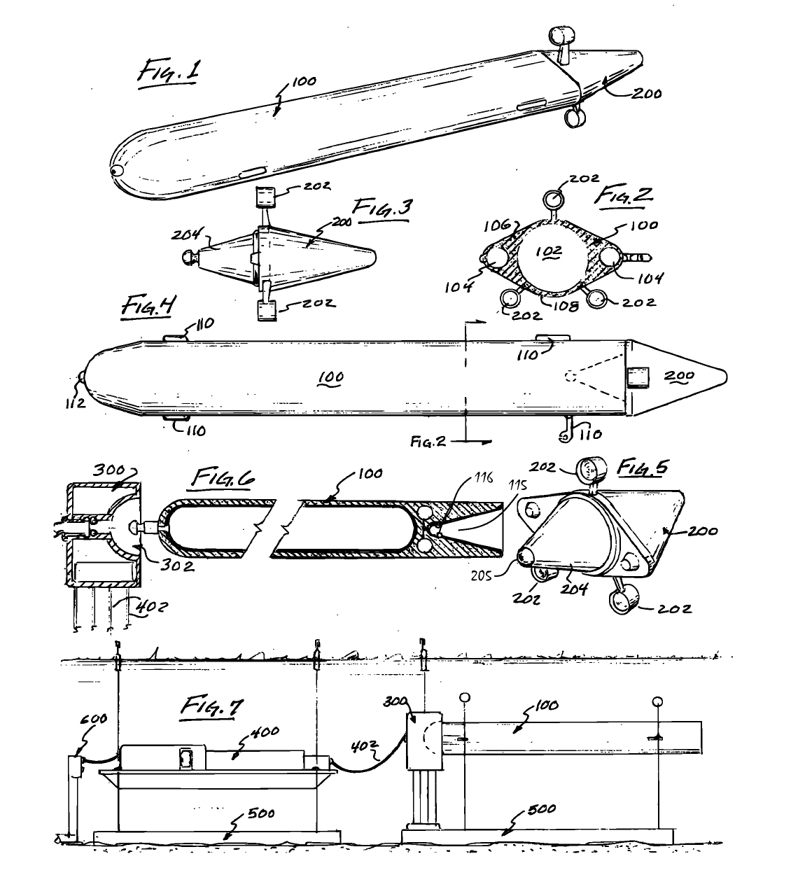

A system according to the preferred embodiment of the present invention is illustrated in FIGS. 1-7. The preferred system includes a computer-controlled submarine tug 200 (sometimes referred to herein as a robotic submersible propulsion unit) that propels (typically by pulling, but in certain cases by, instead or in addition, pushing) a submersible barge 100 that is filled with liquefied natural gas (or in alternate embodiments, another gas, such as liquefied hydrogen, or any other material) below surface traffic and storm disturbances. The system preferably operates regardless of sea conditions. The tug 200 preferably follows a predetermined course (e.g., using an inertial navigation system) while preferably receiving transmitted updates (e.g., GPS-based or other satellite-based updates). After the tug 200 drops the barge 100 off at a gas offloading (or downloading) terminal, it picks up an empty barge, and then returns (or travels to a different generation or extraction facility) to exchange the empty barge with another filled barge, preferably operating on a continuous 24/7 schedule.

As shown in FIG. 2, the transport barge 100 preferably includes a LNG storage tank 102 and two or more ballast tanks 104. Barge 100 preferably is made of fiber-infused insulating foam concrete 106 with an outer shell of fiber-infused high-strength concrete 108 that surrounds one or more plastic composite tanks (such as a storage tank 102 for fuel and, optionally, an additional storage tank for oxygen, as discussed in greater detail below), e.g., similar to the tanks currently used on the space shuttle. The main (preferably concrete) structure of the barge 100 preferably is fabricated in and on the water and then functions to insulate and support the tanks. FIG. 2 also shows the three thrusters 202 of tug 200, to which transport barge 100 is attached.

As shown in FIG. 3, the automated or robotic tug 200 preferably includes two or more (preferably electric-drive or NG-powered-engine) thrusters 202 and, for coupling to transport barge 100, an attachment fitting 204. An onboard computer preferably controls the tug thrusters 202 to move the transport barge forward or (by simply operating in reverse) rearward. In addition, drive power preferably is used to swivel the housings of thrusters 202 in order to provide thrust in the up, down, right and/or left directions, as desired. The electrical propulsion system (if used) preferably is powered by natural gas stored aboard the transport barge (e.g., using a hydrogen fuel cell technology or using a gas-burning turbine or engine that drives an electrical generator). Alternatively, or in addition, a NG-combustion engine, for example, can be used to directly provide some or all of the desired drive power. For any of the foregoing purposes, a separate storage tank (not shown) preferably is provided within the transport barge 100 and carries liquefied oxygen for reacting with the stored fuel. If the stored fuel is hydrogen that has been obtained by breaking down water through the use of electrolyses, oxygen also will be produced and at least some of such oxygen (e.g., an amount sufficient to power the tug 200 to its next destination and, potentially, beyond) preferably is pressurized and stored in this separate tank.

As shown in FIG. 4, the transport barge 100 preferably includes multiple (e.g., four) fold-out mooring cable locks 110 and, at one end, a loading/downloading connection, which preferably is implemented as a fuel connection lock 112 (retracted in FIG. 4). The end at which loading/downloading connection 112 is located preferably is tapered in shape and, more preferably, rounded at the end, thereby facilitating docking operations with loading and downloading terminals.

The loading and downloading gas terminals preferably are moored underwater, offshore, out of view and below storm action. They preferably are portable systems that are fabricated off-site and floated to their deployment location as fully operational systems. As a result, they generally can be deployed or removed from offshore undeveloped sites in a matter of hours and generally do not require extensive coastal land use, expensive unsightly storage or processing facilities.

The submersible barge 100 according to the present invention preferably can be moored and attached to a subsurface offshore gas terminal 400. In one specific embodiment discussed below, the terminal 400 has received natural gas (NG) from an offshore drilling rig (not shown in the drawings) or from an onshore gas line 600. However, it should be understood that the present invention can be used in conjunction with any other material transportation, such as the transportation of hydrogen produced offshore from wind-generating, tidal-generating, ocean-current-generating or wave-generating systems, or for that matter, from any other kind of ocean or land generating systems, or even the transportation of desalinated water produced using such energy sources.

Terminal 400 preferably converts the NG to liquid natural gas (LNG) and pumps it into the barge 100. When the barge 100 is sufficiently filled with LNG, the submarine tug 200 attaches itself to the barge 100, and barge 100 disconnects from its mooring 500 and the terminal 400. The tug 200 then powers the barge 100 on an underwater predetermined course to a downloading gas terminal (not shown in the drawings, but preferably conceptually similar to terminal 400) that could be thousands of miles away. More preferably, the downloading gas terminal preferably is identical to terminal 400 and has an attached transfer connection dock 300, exactly as shown in FIG. 7. Upon arriving, the barge 100 is attached to a download mooring terminal that converts the LNG back to natural gas and pumps it ashore. The tug picks up an empty barge and returns it to a LNG loading terminal 400. In the preferred embodiments, the tug 200 is powered by natural gas stored in tank 102 in the barge 100.

It is noted that, due to the shape of the end of barge 100, most or all of the water will be pushed out when a connection is made between barge 100 and a transfer connection dock 300. However, barge 100 optionally can be supplied with a pumping system so that whenever it connects to a transfer connection dock 300 (for loading or downloading), any remaining water can be removed before the transfer operation begins. Alternatively, such excess water pumps instead could be provided in the loading and/or downloading terminals.

In order to automatically travel among the various points indicated above, tug 200 preferably is provided with a computer-controlled inertial navigation system, using accelerometers and gyroscopes to keep track of changes in its speed and direction. Any conventional submarine inertial navigation system can be used for this purpose. In addition, tug 200 preferably periodically surfaces (or releases a communication buoy to the surface) in order to obtain a GPS (Global Positioning System) reading and thereby more accurately update its position. In certain embodiments, tug 200 also is provided with a satellite (or other radio) communication transmitter or transceiver, thereby permitting communication with a central monitoring and/or control station.

Still further, the tug 200 and/or the barge 100 preferably is/are provided with a radio beacon system (receiver or transceiver). Once sufficiently close to a loading or unloading terminal, a radio beacon provided by the terminal is received and used to guide tug 200 into the connection dock 300 (although in alternate embodiments of the barge 100 or tug 200 generates the beacon signal and it is received by the connection terminal). Again, a conventional radio beacon system can be used for this purpose, and the foregoing beacon system can be used for connecting barge 100 to either or both of tug 200 and connection dock 300). As shown in the drawings, both the locking port 115 and the attachment fitting 204 preferably are tapered in shape so that it is easy for the distal end of attachment fitting 204 to initially fit into the opening of locking port 115. Similarly, the opposite end of barge 100 (having loading/downloading connection 112) preferably also is tapered with to facilitate the connection at that end. Thereafter, simple forward drive will complete the meeting, with spring-loaded electromagnetically retractable clips or other securing mechanisms 116 (or similar mechanisms in transfer connection dock 300) then securing the connection. In addition, at least the connection to transfer connection dock 300 preferably also includes appropriate seals to prevent water intrusion. Each connection (between barge 100 and transfer connection dock 300 and between barge 100 and tug 200) preferably also includes an electrical connection so that the two units can communicate with each other, e.g., in order to instruct the retraction of the securing mechanisms when desired.

In certain embodiments of the invention, when barge 100 is sufficiently full it first is refloated to the surface before disconnecting from transfer connection dock 300 and attaching to tug 200 and, after having been transported to a loading site, connects to transfer connection dock 300 and disconnects from tug 200 before being winched beneath the surface of the water. As indicated in FIG. 7, in the preferred embodiments the major components of the system (including barge 100, the loading terminal 400 and the corresponding downloading terminal) are buoyant in operational use, anchored to the bottom surface (e.g., seabed) and attached to one or more buoys at the surface of the water.

More preferably, the system is made up of the following six major components:

1. A robotic submarine tug 200 is computer-controlled, attaches to, propels and controls the submersible transport barge 100.

2. A submersible transport/storage barge 100 preferably includes a large LNG (or other liquefied gas) storage tank 102 encased in concrete with ballast tanks 104, a tug locking port 115 (preferably at its stern) and a gas loading/downloading connection 112 (preferably at its bow). It could, e.g., have any or all of the features described for the transport barges in U.S. Pat. No. 7,726,911, which is incorporated by reference herein.

3. A loading gas terminal 400 moored below storm action near a NG (or other gas) production facility. The loading terminal 400 preferably is equipped to receive NG, convert it to LNG and pump the LNG aboard the transport barge 100. Alternatively, the terminal can be incorporated into a large offshore support hydrogen production platform.

More generally, the terminals used according to the present invention can have any of a wide variety of different kinds of configurations and purposes.

4. A gas transfer connection dock 300 is located at both the loading and downloading terminals. The transfer dock 300 preferably connects an empty submersible barge 100 to moorings 500 and a transfer hose 402, while the barge 100 is on the ocean (or lake or other water) surface. It then winches the barge 100 below the surface to its operational location. The foregoing operation preferably is then repeated in reverse order when the barge 100 is sufficiently full.

5. A downloading gas terminal (not shown in the drawings but conceptually similar to terminal 400) preferably is moored offshore below storm action and out of the shoreline view shed. It preferably is located near a large NG user, such as a generating plant and/or a NG service grid. It is equipped to convert LNG back to NG which it pumps ashore as needed. Both the loading and downloading terminals preferably are remotely controlled. If they require repair or maintenance, they preferably are re-floated to the surface. As a result, they typically require little or no underwater maintenance work.

6. A re-floatable mooring system 500 preferably is a large deadweight re-floatable concrete anchor, such as described in U.S. Pat. No. 7,726,911. This mooring device 500 gives the entire system mobility. It preferably can be put into operation or removed in a matter of a couple of hours.

The barges, transfer unit and mooring system preferably are monolithic concrete structures fabricated in and on the water using floating molds, such as described in U.S. Pat. No. 7,726,911. The approach described therein is a rapid, cost-effective fabrication method for mass production of large floating concrete structures. It is a portable fabrication system that does not require onshore heavy lifting or handling equipment. The system can produce precise product in backwater areas using semi-skilled local labor. When completed the units are floated to the deployment site as a fully operational system. They can then be deployed in a matter of hours, and do not require onsite underwater construction. If maintenance or repair is required, the system can be quickly re-floated for surface repair or removal. Well-made concrete structures have a low maintenance in-water life of fifty or more years.

Some of the advantages of the present system are as follows:

1. The system is portable. If a mistake were to be made in placing the system or if the system subsequently is no longer needed at that location, it can easily be removed or relocated within a few hours without having to remove fixed underwater facilities.

2. It can be mass-produced in and on the water by semi-skilled labor at a convenient location, at a relatively low cost, and towed to its deployment location as a fully operational system.

3. The gas terminal, mooring dock and mooring system can be installed or removed in a matter of hours with light equipment and little disruption of shipping traffic or normal site use. No unsightly onsite construction is required.

4. With the exception of the transfer gas line, which generally can be manufactured anywhere, the system would not require any onshore construction. Not having to buy coastal land, design, permit, and construct onshore facilities can save a great deal of time and capital investment.

5. Concrete units require little maintenance and have a normal life expectancy of over fifty years.

6. If any component of the system requires repair or replacement, it can be refloated for surface maintenance or else it can be replaced. No underwater maintenance is required.

7. The terminals can be deployed where needed along an undeveloped shore line close to onshore existing facilities or gas lines. This would reduce the need and cost for building new pipelines and unsightly storage facilities.

8. Having many small dispersed terminal systems would lower the chances of catastrophic failure or destruction. It also would allow the placement of a distribution terminal near an existing power plant or NG grid without having to build costly pipelines or electrical grids to distribute power from a large, central land-based facility.

9. The entire system could be moored below surface wave action to avoid storm danger. As a result, it would be out of sight from land, with no view shed issues or damage to the local environment and no hindrance to surface traffic.

10. A robotic or fully or partially automated system could run on a 24/7 basis, speeding delivery and greatly reducing labor and handling equipment cost.

11. With a portable, easy-to-deploy, inexpensive system, it could be used to collect natrual gas or oil from an offshore well (or other offshore production facility, e.g., for producing hydrogen) with a production rate that would not otherwise justify collection.

12. Most importantly, it would be possible to build an infrastructure for the future. The majority of our planet's surface is covered by oceans, and these oceans contain the greatest amount of renewable energy available on earth. The wind energy in the Aleutian Islands alone, if harnessed with floating deepwater wind turbines, could meet most of the present energy needs of the United States. Add to this the use of energy systems to collect the vast power in the Atlantic and Pacific Ocean currents (waves and tides), and we could power the world without killing it.

As to point #12 above, it is possible, for example, to use a subsurface system to convert electrical energy into hydrogen, liquefy the hydrogen, and then transport it throughout the world in robotic submersible barges that can store the energy and transfer it as needed.

The embodiments described above generally pertain to natural-gas or liquefied-natural-gas transport systems. However, it should be understood that references to natural gas herein are merely exemplary, and generally can be replaced by references to any other type of gas (or, for that matter, liquid or any other kind of material). Generally speaking, the term “gas”, as used herein, is intended to refer to any material that is in a gaseous state at ordinary ambient environmental temperatures and pressures.

System Environment.

In the preferred embodiments, most or all of the processes are performed by the computer controller on the tug 200 which is coupled to (and/or incorporates) the controls for the thrusters 202, the navigation system, the beacon system and the satellite or other radio communication system (although in alternate embodiments, any of the other units can be provided with computer processors and/or controllers to distribute the processing in any known manner). According to these preferred embodiments, the computer controller receives signals from the navigation system and uses them to control the thrusters in a manner so as to follow the pre-stored course (or any updates in the course received via the satellite or other radio link). Similarly, the computer controller preferably receives signals from the beacon system and uses them to control the thrusters in a manner so as to guide itself toward the barge 100 or to guide a connected barge 100 into a transfer connection dock 300. At the same time, the computer controller on tug 200 preferably causes position and other status information preferably to be transmitted to a central control and/or monitoring station, and receives and processes updates from the central station.

Generally speaking, except where clearly indicated otherwise, all of the computer-controlled systems, methods, functionality and techniques described herein can be practiced with the use of, and each referenced computer processor or controller can be implemented as, one or more programmable general-purpose computing devices. Such devices typically will include, for example, at least some of the following components interconnected with each other, e.g., via a common bus: one or more central processing units (CPUs); read-only memory (ROM); random access memory (RAM); input/output software and circuitry for interfacing with other devices (e.g., using a hardwired connection, such as a serial port, a parallel port, a USB connection or a firewire connection, or using a wireless protocol, such as Bluetooth or a 802.11 protocol); software and circuitry for connecting to one or more networks, e.g., using a hardwired connection such as an Ethernet card or a wireless protocol, such as code division multiple access (CDMA), global system for mobile communications (GSM), Bluetooth, a 802.11 protocol, or any other cellular-based or non-cellular-based system, which networks, in turn, in many embodiments of the invention, connect to the Internet or to any other networks; a display (such as a cathode ray tube display, a liquid crystal display, an organic light-emitting display, a polymeric light-emitting display or any other thin-film display); other output devices (such as one or more speakers, a headphone set and a printer); one or more input devices (such as a mouse, touchpad, tablet, touch-sensitive display or other pointing device, a keyboard, a keypad, a microphone and a scanner); a mass storage unit (such as a hard disk drive or a solid-state drive); a real-time clock; a removable storage read/write device (such as for reading from and writing to RAM, a magnetic disk, a magnetic tape, an opto-magnetic disk, an optical disk, or the like); a global positioning system (GPS), and a modem (e.g., for sending faxes or for connecting to the Internet or to any other computer network via a dial-up connection). In operation, the process steps to implement the above methods and functionality, to the extent performed by such a general-purpose computer, typically initially are stored in mass storage (e.g., a hard disk or solid-state drive), are downloaded into RAM, and then are executed by the CPU out of RAM. However, in some cases the process steps initially are stored in RAM or ROM. Suitable general-purpose programmable devices for use in implementing the present invention may be obtained from various vendors. In the various embodiments, different types of devices are used.

In addition, although general-purpose programmable devices have been described above, in alternate embodiments one or more special-purpose processors or computers instead (or in addition) are used. In general, it should be noted that, except as expressly noted otherwise, any of the functionality described above can be implemented by a general-purpose processor executing software and/or firmware, by dedicated (e.g., logic-based) hardware, or any combination of these, with the particular implementation being selected based on known engineering tradeoffs. More specifically, where any process and/or functionality described above is implemented in a fixed, predetermined and/or logical manner, it can be accomplished by a processor executing programming (e.g., software or firmware), an appropriate arrangement of logic components (hardware), or any combination of the two, as will be readily appreciated by those skilled in the art. In other words, it is well-understood how to convert logical and/or arithmetic operations into instructions for performing such operations within a processor and/or into logic gate configurations for performing such operations; in fact, compilers typically are available for both kinds of conversions.

It should be understood that the present invention also relates to machine-readable tangible or non-transitory media on which are stored software or firmware program instructions (i.e., computer-executable process instructions) for performing the methods and functionality of this invention. Such media include, by way of example, magnetic disks, magnetic tape, optically readable media such as CDs and DVDs, or semiconductor memory such as various types of memory cards, USB flash memory devices, solid-state drives, etc. In each case, the medium may take the form of a portable item such as a miniature disk drive or a small disk, diskette, cassette, cartridge, card, stick etc., or it may take the form of a relatively larger or less-mobile item such as a hard disk drive, ROM or RAM provided in a computer or other device. As used herein, unless clearly noted otherwise, references to computer-executable process steps stored on a computer-readable or machine-readable medium are intended to encompass situations in which such process steps are stored on a single medium, as well as situations in which such process steps are stored across multiple media.

The foregoing description primarily emphasizes electronic computers and devices. However, it should be understood that any other computing or other type of device instead may be used, such as a device utilizing any combination of electronic, optical, biological and chemical processing that is capable of performing basic logical and/or arithmetic operations.

In addition, where the present disclosure refers to a processor, computer, server device, computer-readable medium or other storage device, client device, or any other kind of device, such references should be understood as encompassing the use of plural such processors, computers, server devices, computer-readable media or other storage devices, client devices, or any other devices, except to the extent clearly indicated otherwise.

Additional Considerations.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A water-based material-transportation system, comprising:
(a) a robotic submersible propulsion unit that includes: a thruster, a computer controller that is coupled to and configured to control the thruster and that causes said robotic submersible propulsion unit to follow a predetermined course, and an attachment fitting; and
(b) a submersible transport barge that includes: a storage tank, a locking port at a first end of the submersible transport barge that detachably connects to the attachment fitting of the robotic submersible propulsion unit, and a loading/downloading connection at a second end of the submersible transport barge that detachably connects to a transfer connection dock for transferring material between the storage tank and the transfer connection dock.

2. A system according to claim 1, wherein the thruster is electrically driven.

3. A system according to claim 1, wherein the robotic submersible propulsion unit includes a plurality of thrusters.

4. A system according to claim 3, wherein the thrusters have housings that swivel to move the robotic submersible propulsion unit up, down, right and left.

5. A system according to claim 1, wherein while following the predetermined course, the robotic submersible propulsion unit receives satellite-based updates.

6. A system according to claim 1, wherein the predetermined course is thousands of miles long.

7. A system according to claim 1, wherein the storage tank stores liquefied gas.

8. A system according to claim 1, wherein the loading/downloading connection comprises a retractable fuel connection lock.

9. A system according to claim 1, wherein the computer controller causes the robotic submersible propulsion unit to follow the predetermined course underwater.

10. A system according to claim 1, wherein the storage tank is surrounded by fiber-infused insulating foam concrete with an outer shell of fiber-infused high-strength concrete.

11. A system according to claim 1, wherein the storage tank stores at least one of liquefied natural gas and liquefied hydrogen.

12. A system according to claim 1, wherein the attachment fitting is tapered in shape.

13. A system according to claim 1, wherein the computer controller controls the thruster using an inertial navigation system and periodic GPS updates.

14. A system according to claim 1, wherein the computer controller controls the thruster so as to cause the attachment fitting of the robotic submersible propulsion unit to connect to the locking port of the submersible transport barge using a radio beacon system.

15. A system according to claim 1, wherein the computer controller controls the thruster so as to cause the loading/downloading connection of the submersible transport barge to connect to the transfer connection dock using a radio beacon system.
